(19) United States
(12) Patent Application Publication
(10) Pub. No.: US 2025/0206876 A1
(43) Pub. Date: Jun. 26, 2025

(54) TWO COMPONENT (2K) EPOXY FORMULATION

(71) Applicant: Henkel AG & Co. KGaA, Duesseldorf (DE)

(72) Inventors: Fabio Sarcina, Milan (IT); Eleonora Salmoiraghi, Sedriano (IT); Martina Longoni, Dresano (IT)

(21) Appl. No.: 19/078,524

(22) Filed: Mar. 13, 2025

Related U.S. Application Data
(63) Continuation of application No. PCT/EP2023/076742, filed on Sep. 27, 2023.

(30) Foreign Application Priority Data
Oct. 12, 2022 (EP) 22201079.5

(51) Int. Cl. C08G 59/50; C08G 59/56; C08G 59/62; C09J 163/00

(52) U.S. Cl. CPC C08G 59/5006; C08G 59/5026; C08G 59/5033; C08G 59/56; C08G 59/621; C09J 163/00

(57) ABSTRACT

The present invention is directed to a two-component (2K) curable composition comprising:
a first component comprising:
   a) at least one epoxy resin; and,
a second component comprising:
   b) a mixture of polyamines of which each polyamine has at least two amine hydrogens reactive toward epoxide groups, said mixture comprising:
      b) i) meta-xylenediamine (MXDA); and,
      b) ii) at least one cycloaliphatic primary diamine; and/or,
      b) iii) at least one aliphatic primary diamine compound, which compound further comprises one or more secondary amine groups; and,
   c) at least one phenolic aldehyde resin obtained by reacting at least one phenolic compound and at least one aldehyde having the general formula R^{a}—(CHO)_{b}, wherein:
      R^{a} is H, C₁-C₁₈ alkyl, C₂-C₁₈ alkenyl, C₆-C₁₈ aryl, C₇-C₁₈ alkylaryl or C₇-C₁₈ aralkyl; and,
      b is 1 or 2,
wherein said curable composition is characterized by a stoichiometric ratio of the amine hydrogen atoms of said second component to the epoxy groups of said first component (a) of from 0.5:1 to 1.2:1, preferably from 0.8:1 to 1.0:1.

### TECHNICAL FIELD

The present invention relates to a two-component (2K) curable composition based on epoxy resin. More particularly, the present invention is directed to a low-toxicity, two-component (2K) curable composition which is characterized by containing an epoxy resin in a first component and an amine functional hardener or curative in a second component.

### TECHNICAL BACKGROUND

Epoxy resins have found a broad range of application, predominantly on the basis that a particular selection of resin, modifier and cross-linking agent (or curative) can allow the properties of the cured epoxy resin to be tailored to achieve specific performance characteristics.

That versatility being acknowledged, properly cured epoxy resins also possess a plurality of other attributes including interalia: excellent chemical resistance, particularly to alkaline environments; high tensile and compressive strengths; high fatigue strength; low shrinkage upon cure; ability to cure over a range of temperatures; and, electrical insulation properties and retention thereof upon aging or environmental exposure.

Despite their recognized benefits, known reactive epoxy resin systems often contain constituents that are categorized—and consequently commercially labelled—as: corrosive (C); toxic (T); very toxic (T+); harmful (Xn); irritating (Xi); sensitizing; and/or, hazardous. In European Union countries, it is common for commercial epoxy resin systems to be labelled with their trade name, the chemical name of the hazardous components of the preparation, danger symbols, risk (R—) phrases and safety (S—) phrases.

For reasons of environmental protection, safety and industrial hygiene, it is important to develop reactive epoxy resin-containing preparations that do not require such labeling and which exhibit a reduced sensitizing potential. Such preparations should however be developed without compromising the physicochemical properties and technical processing conditions of the epoxy resins.

One known route of lowering the toxicity of epoxy-based compositions is to use Mannich bases as the curative. For example, U.S. Pat. No. 6,262,148 (Bender et al.) describes the use of phenalkamines based on cardanol and meta-xylenediamine (MXDA) as hardeners for epoxy-based coatings. Such hardeners are however complex to produce and are considered to have too high a viscosity for good processibility in coating applications without further dilution. These difficulties have thus prompted the investigation of alternative low-toxicity curatives.

U.S. Pat. No. 8,642,709 (Walter et al.) discloses a two-component (2K) composition comprising first and second components wherein:
i) the first component is a mixture of reactive epoxy resins comprising, based on the mass of all epoxy resins
   a) 30 to 45 wt. % of an epoxy group-containing reaction product of epichlorohydrin with polypropylene glycol which has an epoxy equivalent weight of at least 250 g/eq;
   b) 30 to 45 wt. % of an epoxy group-containing reaction product of epichlorohydrin with a novolac resin which has an epoxy equivalent weight of at least 175 g/eq;
   c) 10 to 40 wt. % of an epoxy group-containing reaction product of epichlorohydrin with bisphenol A, which has an epoxy equivalent weight of at least 500 g/eq; and,
   d) optionally, formulation constituents; and,
ii) the second component contains at least one thiol group-containing hardener for epoxy resins.

U.S. Pat. No. 11,053,346 (Gerber) describes a low-toxicity hardener for epoxy resins comprising: a) an adduct (AD) obtained from the reaction of: i) at least one novolak glycidyl ether containing an average of 2.5 to 4 epoxy groups per molecule; and, ii) an amine mixture comprising bis(6-aminohexyl)amine and at least one amine (A1) other than bis(6-aminohexyl)amine that has at least one primary amino group; and, b) at least one further amine (A2) other than bis(6-aminohexyl)amine that has at least two amine hydrogens reactive toward epoxy groups per molecule.

US20190177472 (Kasemi et al.) discloses a hardener for epoxy resins which is purported to be a low-odor, low-viscosity, low-toxicity curing agent and which has a low propensity for carbamatization and a high reactivity toward epoxy resins. The described hardener comprises: i) at least one amine of the formula (I)

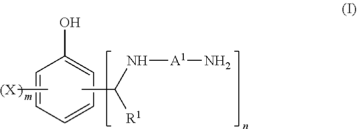

wherein: A¹ is an alkylene radical which has 2 to 15 carbon atoms and which is not 1,2-propylene; R¹ is a hydrogen radical, an alkyl radical having 1 to 8 carbon atoms or a phenyl radical; X represents identical or different radicals selected from the group consisting of hydroxyl, alkyl, alkenyl and alkoxy each having 1 to 18 carbon atoms; m is 0 or 1 or 2; and, n is 1, 2 or 3; and, ii) at least one amine of the formula (II)

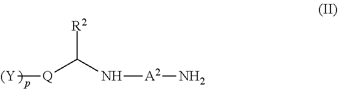

wherein: A² is an alkylene radical selected from 1,2-ethylene and 1,2-propylene; R² is a hydrogen or methyl or phenyl radical; Q is a five-, six- or seven-membered cycloalkyl or aryl radical and having 4 to 7 carbon atoms; Y represents identical or different radicals selected from the group consisting of alkyl, alkoxy and dialkylamino each having 1 to 18 carbon atoms; and, p is 0, 1, 2 or 3.

There is considered to be a need in the art to prepare alternative curable compositions which are based on epoxy resins and which exhibit low toxicity but of which the cured product is not compromised as regards its physicochemical properties.

### STATEMENT OF THE INVENTION

In accordance with a first aspect of the invention, there is provided a two-component (2K) curable composition comprising:
a first component comprising:
   a) at least one epoxy resin; and,
a second component comprising:
   b) a mixture of polyamines of which each polyamine has at least two amine hydrogens reactive toward epoxide groups, said mixture of polyamines comprising:
      b) i) meta-xylenediamine (MXDA); and,
      b) ii) at least one cycloaliphatic primary diamine; and/or,
      b) iii) at least one aliphatic primary diamine compound, which compound further comprises one or more secondary amine groups; and,
   c) at least one phenolic aldehyde resin obtained by reacting at least one phenolic compound and at least one aldehyde having the general formula R^{a}—(CHO)_{b}, wherein:
      R^{a} is H, C₁-C₁₈ alkyl, C₂-C₁₈ alkenyl, C₆-C₁₈ aryl, C₇-C₁₈ alkylaryl or C₇-C₁₈ aralkyl; and,
      b is 1 or 2,
wherein said curable composition is characterized by a stoichiometric ratio of the total amine hydrogen atoms of said second component to the epoxy groups of said first component (a) of from 0.5:1 to 1.2:1, preferably from 0.8:1 to 1.0:1.

For completeness, the mixture of polyamines in the curative component may comprise either or both of said diamine compounds b)ii) and b)iii).

In an embodiment, part a) of the composition comprises at least one polyepoxide compound having an epoxide equivalent weight of from 100 to 700 g/eq. In particular, part a) may comprise at least one polyepoxide compound selected from the group consisting of: glycidyl ethers of polyhydric alcohols; glycidyl ethers of polyhydric phenols; glycidyl esters of polycarboxylic acids; and, epoxidized polyethylenically unsaturated hydrocarbons.

Effective compositions have been obtained wherein said part a) comprises at least one diepoxide compound having an epoxide equivalent weight of less than 500 g/eq. In this instance, it is particularly preferred that part a) comprises at least one diepoxide compound selected from the group consisting of: bisphenol A based diglycidylethers; hydrogenated bisphenol A based diglycidylethers; bisphenol F diglycidyl ethers; and, hydrogenated bisphenol F based diglycidylethers.

Either supplementary to or independently of the preferred forms of the epoxy resin a), it is preferred that, within the mixture of polyamines of the second component, both of b) ii) said at least one cycloaliphatic primary diamine and b) iii) said at least one aliphatic primary diamine compound are characterized by an amine hydrogen equivalent weight of not more than 150 g/eq. Good results have in particular been obtained where b) iii) said at least one aliphatic primary diamine compound is selected from the group consisting of: 3-(2-aminoethyl)aminopropylamine; triethylenetetramine (TETA); tetraethylenepentamine (TEPA); and, pentaethylenehexamine (PEHA). A particular preference may be mentioned for the presence of triethylenetetramine (TETA) in the mixture of polyamines of the second component.

In an embodiment, the two component (2K) composition comprises from 5 to 30 wt. %, based on the weight of the composition, of c) said least one phenolic aldehyde resin. Independently of or additional to this statement, it is preferred that said at least one phenolic aldehyde resin (c)) is obtained by reacting at least one phenolic compound and at least one aldehyde having the general formula R^{a}—(CHO)_{b}, wherein: R^{a} is H, C₁-C₈ alkyl or C₂-C₈ alkenyl; and, b is 1 or 2. Desirably, said at least one phenolic compound comprises or consists of phenol and most desirably part c) of the composition comprises or consists of phenol-formaldehyde resin.

The two-component (2K) compositions of the present invention present limited carcinogenicity and mutagenicity and have a low toxicity and low repro-toxicity profile. Further, the presence of the m-xylenediamine (MXDA) in the curative component contributes aromatic rings to the backbone of the cured product and thereby delivers advantageous hardness, chemical resistance and thermal resistance. The aromaticity further contributes to a workable glass transition temperature (Tg).

With being bound by theory, the further diamine constituents(s) of the polyamine mixture—b) ii) and/or b) iii)—preserve a very processable curing speed of the composition. The phenolic aldehyde resin is considered to act as an effective diluent for the MXDA and further polyamines.

In accordance with a second aspect of the invention, there is provided a cured product obtained from the two component (2K) curable composition as defined herein above and in the appended claims. The present invention also provides for the use of that cured reaction product as a coating, adhesive or sealant.

### Definitions

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps. If used, the phrase “consisting of” is closed and excludes all additional elements. Further, the phrase “consisting essentially of” excludes additional material elements but allows the inclusion of non-material elements that do not substantially change the nature of the invention.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Further, in accordance with standard understanding, a weight range represented as being “from 0 to x” specifically includes 0 wt. %: the ingredient defined by said range may be absent from the composition or may be present in the composition in an amount up to x wt. %.

The terms “preferred”, “preferably”, “desirably”, “particularly”, “in particular” and synonyms thereof, are used frequently herein to refer to embodiments of the disclosure that may afford particular benefits, under certain circumstances. However, the recitation of one or more preferable, preferred, desirable or particular embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

As used herein, room temperature is 23° C. plus or minus 2° C. As used herein, “ambient conditions” means the temperature and pressure of the surroundings in which the composition is located or in which a coating layer or the substrate of said coating layer is located.

The molecular weights referred to in this specification can be measured with gel permeation chromatography (GPC) using polystyrene calibration standards, such as is done according to ASTM 3536.

Viscosities of the coating compositions described herein are, unless otherwise stipulated, measured using the Brookfield Viscometer at standard conditions of 25° C. and 50% Relative Humidity (RH). The method of calibration, the spindle type and rotation speed of the Brookfield Viscometer are chosen according to the instructions of the manufacturer as appropriate for the composition to be measured.

The term “acute toxicity” is defined in the European Chemicals Agency Guidance to Regulation (EC) No 1272/2008 on classification, labelling and packaging (CLP) of substances and mixtures, Version 5.0, 7:2017 as meaning those adverse effects occurring following oral or dermal administration of a single dose of a substance or a mixture, or multiple doses given within 24 hours, or an inhalation exposure of 4 hours. Chemicals can be allocated to one of five toxicity categories based on acute toxicity by the oral, dermal or inhalation route according to the numeric criteria expressed as (approximate) LD50 (oral, dermal) or LC50 (inhalation) values. Where applicable, the formulae provided in the aforementioned Guidance for the calculation of the acute toxicity estimate (ATE) values for mixtures of ingredients (ATE_{Mix})—including mixtures where the ATE of individual components of the mixture is not known—have been used.

As used herein, the term “equivalent (eq.”) relates, as is usual in chemical notation, to the relative number of reactive groups present in the reaction.

The term “monofunctional”, as used herein, refers to having one polymerizable moiety. The term “polyfunctional”, as used herein, refers to having more than one polyrnerizable moiety.

As used herein, the term “equivalent (eq.”) relates, as is usual in chemical notation, to the relative number of reactive groups present in the reaction.

The term “equivalent weight” as used herein refers to the molecular weight divided by the number of a function concerned. As such, “epoxy equivalent weight” (EEW) means the weight of resin, in grams, that contains one equivalent of epoxy. Equally, the “amine hydrogen equivalent weight” (AHEW) is the weight of the organic amine, in grams, that contains one amine hydrogen.

As used herein, the term “epoxide” denotes a compound characterized by the presence of at least one cyclic ether group, namely one wherein an ether oxygen atom is attached to two adjacent carbon atoms thereby forming a cyclic structure. The term is intended to encompass monoepoxide compounds, polyepoxide compounds (having two or more epoxide groups) and epoxide terminated prepolymers. The term “monoepoxide compound” is meant to denote epoxide compounds having one epoxy group. The term “polyepoxide compound” is meant to denote epoxide compounds having at least two epoxy groups. The term “diepoxide compound” is meant to denote epoxide compounds having two epoxy groups.

The epoxide may be unsubstituted but may also be inertly substituted. Exemplary inert substituents include chlorine, bromine, fluorine and phenyl.

As used herein, “(meth)acryl” is a shorthand term referring to “acryl” and/or “methacryl”. Thus, the term “(meth)acrylamide” refers collectively to acrylamide and methacrylamide.

As used herein, “C₁-Cₙ alkyl” group refers to a monovalent group that contains 1 to n carbons atoms, that is a radical of an alkane and includes straight-chain and branched organic groups. As such, a “C₁-C₁₈ alkyl” group refers to a monovalent group that contains from 1 to 18 carbons atoms, that is a radical of an alkane and includes straight-chain and branched organic groups. Examples of alkyl groups include but are not limited to: methyl; ethyl; propyl; isopropyl; n-butyl; isobutyl; sec-butyl; tert-butyl; n-pentyl; n-hexyl; n-heptyl; and, 2-ethylhexyl. In the present invention, such alkyl groups may be unsubstituted or may be substituted with one or more halogen. Where applicable for a given moiety (R), a tolerance for one or more non-halogen substituents within an alkyl group will be noted in the specification.

The term “C₁-C₁₈ hydroxyalkyl” as used herein refers to a HO-(alkyl) group having from 1 to 18 carbon atoms, where the point of attachment of the substituent is through the oxygen-atom and the alkyl group is as defined above.

An “alkoxy group” refers to a monovalent group represented by -OA where A is an alkyl group: non-limiting examples thereof are a methoxy group, an ethoxy group and an iso-propyloxy group. The term “C₁-C₁₈ alkoxyalkyl” as used herein refers to an alkyl group having an alkoxy substituent as defined above and wherein the moiety (alkyl-O-alkyl) comprises in total from 1 to 18 carbon atoms: such groups include methoxymethyl (—CH₂OCH₃), 2-methoxyethyl (—CH₂CH₂OCH₃) and 2-ethoxyethyl. Analogously, the term “C₇-C₁₈ alkoxyaryl” as used herein refers to an aryl group having an alkoxy substituent as defined above and wherein the moiety (aryl-O-alkyl) comprises in total from 7 to 18 carbon atoms.

The term “C₂-C₄ alkylene” as used herein, is defined as saturated, divalent hydrocarbon radical having from 2 to 4 carbon atoms.

The term “C₅-C₁₈ cycloalkyl” is understood to mean a saturated, mono- or polycyclic hydrocarbon group having from 3 to 18 carbon atoms. In the present invention, such cycloalkyl groups may be unsubstituted or may be substituted with one or more halogen. Where applicable for a given moiety (R), a tolerance for one or more non-halogen substituents within a cycloalkyl group will be noted in the specification. Examples of cycloalkyl groups include: cyclopropyl; cyclobutyl; cyclopentyl; cyclohexyl; cycloheptyl; cyclooctyl; adamantane; and, norbornane.

As used herein, “C₂-C₁₈ alkenyl” refers to hydrocarbyl groups having from 2 to 18 carbon atoms and at least one unit of ethylenic unsaturation. The alkenyl group can be straight chained, branched or cyclic and may optionally be substituted with one or more halogen. Where applicable for a given moiety (R), a tolerance for one or more non-halogen substituents within an alkenyl group will be noted in the specification. The term “alkenyl” also encompasses radicals having “cis” and “trans” configurations, or alternatively, “E” and “Z” configurations, as appreciated by those of ordinary skill in the art. Examples of said C₂-C₂₀ alkenyl groups include, but are not limited to: —CH═CH₂; —CH═CHCH₃; —CH₂CH═CH₂; —C(═CH₂)(CH₃); —CH═CHCH₂CH₃; —CH₂CH═CHCH₃; —CH₂CH₂CH═CH₂; —CH═C(CH₃)₂; —CH₂C(═CH₂)(CH₃); —C(═CH₂)CH₂CH₃; —C(CH₃)═CHCH₃; —C(CH₃)CH═CH₂; —CH═CHCH₂CH₂CH₃; —CH₂CH═CHCH₂CH₃; —CH₂CH₂CH═CHCH₃; —CH₂CH₂CH₂CH═CH₂; —C(═CH₂)CH₂CH₂CH₃; —C(CH₃)═CHCH₂CH₃; —CH(CH₃)CH═CHCH; —CH(CH₃)CH₂CH═CH₂; —CH₂CH═C(CH₃)₂; 1-cyclopent-1-enyl; 1-cyclopent-2-enyl; 1-cyclopent-3-enyl; 1-cyclohex-1-enyl; 1-cyclohex-2-enyl; and, 1-cyclohexyl-3-enyl.

As used herein, an “C₆-C₁₈ aryl” group used alone or as part of a larger moiety—as in “aralkyl group”—refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present invention, such aryl groups may be unsubstituted or may be substituted with one or more halogen. Where applicable for a given moiety (R), a tolerance for one or more non-halogen substituents within an aryl group will be noted in the specification. Exemplary aryl groups include: phenyl; (C₁-C₄)alkylphenyl, such as tolyl and ethylphenyl; indenyl; naphthalenyl, tetrahydronaphthyl, tetrahydroindenyl; tetrahydroanthracenyl; and, anthracenyl. And a preference for phenyl groups may be noted.

As used herein, “alkylaryl” refers to alkyl-substituted aryl groups, both groups being defined as above. Further, as used herein “aralkyl” means an alkyl group substituted with an aryl radical as defined above.

The term “hetero” as used herein refers to groups or moieties containing one or more heteroatoms, such as N, O, Si and S. Thus, for example “heterocyclic” refers to cyclic groups having, for example, N, O, Si or S as part of the ring structure. “Heteroalkyl”, “heterocycloalkyl” and “heteroaryl” moieties are alkyl, cycloalkyl and aryl groups as defined hereinabove, respectively, containing N, O, Si or S as part of their structure.

As used herein, “metallic” means any type of metal, metal alloy, or mixture thereof.

As used herein, the term “catalytic amount” means a sub-stoichiometric amount of catalyst relative to a reactant, except where expressly stated otherwise.

As employed herein a “primary amino group” refers to an NH₂ group that is attached to an organic radical, and a “secondary amino group” refers to an NH group that is attached to two organic radicals, which may also together be part of a ring. The term “tertiary amine” thus references a nitrogen bearing moiety of which a nitrogen atom is not bound to a hydrogen atom. Where used, the term “amine hydrogen” refers to the hydrogen atoms of primary and secondary amino groups.

The term “meta-xylenediamine” is sometimes abbreviated herein to m-xylenediamine or MXDA. According to IUPAC nomenclature MXDA is 1,1′-(1,3-phenylene)di(methanamine) and this IUPAC name may be substituted herein at each instance of reference to meta-xylenediamine or MXDA.

As used herein, “anhydrous” means the relevant composition includes less than 0.25% by weight of water. For example, the composition may contain less than 0.1% by weight of water or be completely free of water. The term “essentially free of solvent” should be interpreted analogously as meaning the relevant composition comprises less than 0.25% by weight of solvent.

The present compositions may be defined herein as being “substantially free” of certain compounds, elements, ions or other like components. The term “substantially free” is intended to mean that the compound, element, ion or other like component is not deliberately added to the composition and is present, at most, in only trace amounts which will have no (adverse) effect on the desired properties of the composition. An exemplary trace amount is less than 1000 ppm by weight of the composition. The term “substantially free” expressly encompasses those embodiments where the specified compound, element, ion, or other like component is completely absent from the composition or is not present in any amount measurable by techniques generally used in the art.

### DETAILED DESCRIPTION OF THE INVENTION

### First Component

### a) Epoxide Compounds

The first component of the two (2K) component composition comprise a) at least one epoxy resin. It is desired that the two (2K) component composition comprises, based on the weight of the composition, from 20 to 60 wt. %, preferably from 25 to 50 wt. % of a) said at least one epoxy resin.

Epoxy resins as used herein may include mono-functional epoxy resins, multi- or poly-functional epoxy resins, and combinations thereof. The epoxy resins may be pure compounds but equally may be mixtures epoxy functional compounds, including mixtures of compounds having different numbers of epoxy groups per molecule. An epoxy resin may be saturated or unsaturated, aliphatic, cycloaliphatic, aromatic or heterocyclic and may be substituted. Further, the epoxy resin may also be monomeric or polymeric.

Without intention to limit the present invention, illustrative monoepoxide compounds include: alkylene oxides; epoxy-substituted cycloaliphatic hydrocarbons, such as cyclohexene oxide, vinylcyclohexene monoxide, (+)-cis-limonene oxide, (+)-cis,trans-limonene oxide, (−)-cis,trans-limonene oxide, cyclooctene oxide, cyclododecene oxide and α-pinene oxide; epoxy-substituted aromatic hydrocarbons; monoepoxy substituted alkyl ethers of monohydric alcohols or phenols, such as the glycidyl ethers of aliphatic, cycloaliphatic and aromatic alcohols; monoepoxy-substituted alkyl esters of monocarboxylic acids, such as glycidyl esters of aliphatic, cycloaliphatic and aromatic monocarboxylic acids; monoepoxy-substituted alkyl esters of polycarboxylic acids wherein the other carboxy group(s) are esterified with alkanols; alkyl and alkenyl esters of epoxy-substituted monocarboxylic acids; epoxyalkyl ethers of polyhydric alcohols wherein the other OH group(s) are esterified or etherified with carboxylic acids or alcohols; and, monoesters of polyhydric alcohols and epoxy monocarboxylic acids, wherein the other OH group(s) are esterified or etherified with carboxylic acids or alcohols.

By way of example, the following glycidyl ethers might be mentioned as being particularly suitable monoepoxide compounds for use herein: ethyl glycidyl ether; propyl glycidyl ether; pentyl glycidyl ether; hexyl glycidyl ether; cyclohexyl glycidyl ether; 2-ethylhexyl glycidyl ether; benzyl glycidyl ether; 4-tert-butylphenyl glycidyl ether; 2-chlorophenyl glycidyl ether; 4-chlorophenyl glycidyl ether; 4-bromophenyl glycidyl ether; 2,4,6-trichlorophenyl glycidyl ether; 2,4,6-tribromophenyl glycidyl ether; and, pentafluorophenyl glycidyl ether. In particular, there may be used one or more glycidyl ethers selected from the group consisting of: ethyl glycidyl ether; pentyl glycidyl ether; 2-ethylhexyl glycidyl ether; benzyl glycidyl ether; 4-tert-butylphenyl glycidyl ether; 2-chlorophenyl glycidyl ether; and, 4-chlorophenyl glycidyl ether.

In an important embodiment, the monoepoxide compound conforms to Formula (III) herein below:

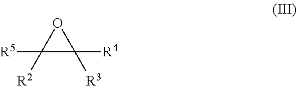

wherein: R², R³, R⁴ and R⁵ may be the same or different and are independently selected from hydrogen, a halogen atom, a C₁-C₈ alkyl group, a C₃ to C₁₀ cycloalkyl group, a C₂-C₁₂ alkenyl, a C₆-C₁₈ aryl group or a C₇-C₁₈ aralkyl group, with the proviso that at least one of R³ and R⁴ is not hydrogen.

It is preferred that R², R³ and R⁵ are hydrogen and R⁴ is either a phenyl group or a C₁-C₈ alkyl group and, more preferably, a C₁-C₄ alkyl group.

Having regard to this embodiment, exemplary monoepoxides include: 1,2-epoxyhexane; 1,2-heptylene oxide; decene oxide; butadiene oxide; and, isoprene oxide.

In the present invention, reference is made to using at least one monoepoxide compound selected from the group consisting of: (+)-cis-limonene oxide; (+)-cis,trans-limonene oxide; (−)-cis,trans-limonene oxide; cyclooctene oxide; and, cyclododecene oxide.

Again, without intention to limit the present invention, suitable polyepoxide compounds may be liquid, solid or in solution in solvent. Further, such polyepoxide compounds should have an epoxide equivalent weight of from 100 to 700 g/eq, for example from 120 to 320 g/eq. And generally, diepoxide compounds having epoxide equivalent weights of less than 500 g/eq. or even less than 400 g/eq. are preferred: this is predominantly from a cost's standpoint, as in their production, lower molecular weight epoxy resins require more limited processing in purification.

As examples of types or groups of polyepoxide compounds which may be polymerized in the present invention, mention may be made of: glycidyl ethers of polyhydric alcohols and polyhydric phenols; glycidyl esters of polycarboxylic acids; and, epoxidized polyethylenically unsaturated hydrocarbons.

Suitable diglycidyl ether compounds may be aromatic, aliphatic or cycloaliphatic in nature and, as such, can be derivable from dihydric phenols and dihydric alcohols. And useful classes of such diglycidyl ethers are: diglycidyl ethers of aliphatic and cycloaliphatic diols, such as 1,4-butanediol, 2,2-dimethyl-1,3-propanediol, 1,6-hexanediol, 1,8-octanediol, 1,12-dodecanediol and cyclohexane dimethanol; bisphenol A based diglycidylethers; bisphenol-A epichlorohydrin based epoxy resins; bisphenol F diglycidyl ethers; diglycidyl terephthalate; polyalkyleneglycol based diglycidyl ethers, in particular polypropyleneglycol diglycidyl ethers; and, polycarbonatediol based glycidyl ethers. Other suitable diepoxides which might also be mentioned include: diepoxides of double unsaturated fatty acid C₁-C₁₈ alkyl esters; dimer acid diglycidyl esters; polybutadiene diglycidyl ether; and, limonene diepoxide.

Further exemplary polyepoxide compounds having utility in the present invention include: glycerol polyglycidyl ether; bis(2,3-epoxy-2-methylpropyl)ether; trimethylol ethane triglycidyl ether; trimethylolpropane polyglycidyl ether; pentaerythritol polyglycidyl ether; diglycerol polyglycidyl ether; polyglycerol polyglycidyl ether; sorbitol polyglycidyl ether; propoxylated glycerol polyglycidyl ether; polyglycidyl ether of castor oil; epoxidized propylene glycol dioleates; 1,2-tetradecane oxides; and, internally epoxidized 1,3-butadiene homopolymers.

And examples of highly preferred polyepoxide compounds include: flexibilizing epoxy resins available as Heloxy™ Modifier Numbers 32, 56, 67, 68, 69, 71, 84, 107, and 505 available from Shell Chemical Company; epoxy novolac resins, such as resins of the EPIKOTE™ and EPON™ series available from Hexion and DEN™ 438 available from Dow Chemical Company; bisphenol-A epoxy resins, such as DER™ 331, and DER™ 383; bisphenol-F epoxy resins, such as DER™ 354; bisphenol-A/F epoxy resin blends, such as DER™ 353; aliphatic glycidyl ethers, such as DER™ 736; polypropylene glycol diglycidyl ethers, such as DER™ 732; solid bisphenol-A epoxy resins, such as DER™ 661 and DER™ 664 UE; solutions of bisphenol-A solid epoxy resins, such as DER™ 671-X75; castor oil triglycidyl ether, such as ERISYS™ GE-35H; polyglycerol-3-polyglycidyl ether, such as ERISYS™ GE-38; sorbitol glycidyl ether, such as ERISYS™ GE-60; and, Poly BD 600, Poly BD 650, Vikoflex™ 4050 and Vikoflex™ 5075 available from Elf Atochem.

The above aside, the composition can in certain embodiments comprise glycidoxy alkyl alkoxy silanes having the formula:

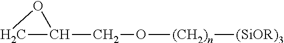

wherein: each R is independently selected from methyl or ethyl; and,
   n is from 1-10.

Exemplary silanes include but are not limited to: γ-glycidoxy propyl trimethoxy silane, γ-glycidoxy ethyl trimethoxy silane, γ-glycidoxy methyl trimethoxy silane, γ-glycidoxy methyl triethoxy silane, γ-glycidoxy ethyl triethoxy silane, γ-glycidoxy propyl triethoxy silane; and, 8-glycidooxyoctyl trimethoxysilane. When present, the epoxide functional silanes should constitute less than 10 wt. %, preferably less than 5 wt. % or less than 2 wt. %, based on the total weight of the epoxide compounds.

The present invention does not preclude the first component of the curable compositions from further comprising one or more cyclic monomers selected from the group consisting of: oxetanes; cyclic carbonates; cyclic anhydrides; and, lactones. The disclosures of the following citations may be instructive in disclosing suitable cyclic carbonate functional compounds: U.S. Pat. Nos. 3,535,342; 4,835,289; 4,892,954; UK Patent No. GB-A-1,485,925; and, EP-A-0 119 840. However, such cyclic co-monomers should constitute less than 10 wt. %, preferably less than 7.5 wt. % or less than 5 wt. %, based on the total weight of the epoxide functional compounds in the first component.

### Second Component

### b) Reactant Polyamines

The second or curative component of the composition necessarily comprises b) i) meta-xylenediamine (MXDA). That curative component further comprises: b) ii) at least one cycloaliphatic primary diamine; and/or, b) iii) at least one aliphatic primary diamine compound, which compound further comprises one or more secondary amine groups. In an important embodiment, b) ii) said at least one cycloaliphatic primary diamine and b) iii) said at least one aliphatic primary diamine compound are each characterized by an amine hydrogen equivalent weight of not more than 150 g/eq.

Exemplary cycloaliphatic primary diamines (b) ii)), which may be used alone or in combination, include: 1,2-, 1,3- and 1,4-diaminocyclohexane; bis(4-aminocyclohexyl)methane (PACM); bis(4-amino-3,5-dimethylcyclohexyl)methane; 1-amino-3-aminomethyl-3,5,5-trimethylcyclohexane (isophorone diamine, IPDA); 2- and/or 4-methyl-1,3-diaminocyclohexane; 1,3-bis(aminomethyl)-cyclohexane; 2,5(2,6)-bis(aminomethyl)-bicyclo[2.2.1]heptane (norborane diamine, NBDA); 3(4),8(9)-bis(aminomethyl)tricyclo[5.2.1.0^{2,6}]-decane (TCD-diamine).

Exemplary aliphatic primary diamine compounds with secondary amine groups (b) iii)), which compounds may be used alone or in combination, include: triethylenetetramine (TETA); tetraethylenepentamine (TEPA); pentaethylenehexamine (PEHA); higher homologs of linear polyethyleneamines, such as polyethylene polyamines with 5 to 7 ethyleneamine units (so-called “higher ethylenepolyamine,” HEPA); products from the multiple cyanoethylation or cyanobutylation and subsequent hydrogenation of primary di- and polyamines with at least two primary amine groups, such as dipropylenetriamine (DPTA), N-(2-aminoethyl)-1,3-propanediamine (N3-amine), N,N′-bis(3-aminopropyl)ethylenediamine (N4-amine), N,N′-bis(3-aminopropyl)-1,4-diaminobutane, N5-(3-aminopropyl)-2-methyl-1,5-pentanediamine, N3-(3-aminopentyl)-1,3-pentanediamine, N5-(3-amino-1-ethylpropyl)-2-methyl-i1,5-pentanediamine or N,N′-bis(3-amino-1-ethylpropyl)-2-methyl-1,5-pentanediamine.

In accordance with a preferred embodiment, said aliphatic primary diamine compound (b) iii)) is selected from the group consisting of: triethylenetetramine (TETA); tetraethylenepentamine (TEPA); and, pentaethylenehexamine (PEHA).

As noted above, when formulating the two component (2K) curable composition, it must in toto be characterized by a stoichiometric ratio of the active hydrogen atoms of said second component to the epoxide groups of said first component (a) of from 0.5:1 to 1.2:1, for example from 0.8:1 to 1.0:1.

In addition to meeting this equivalence ratio, in an embodiment the second component is further characterized by comprising, based on the total weight of polyamines in said second component:
from 5 to 50 wt. %, preferably from 20 to 50 wt. % of b) i) meta-xylenediamine (MXDA);
from 50 to 95 wt. %, preferably from 50 to 80 wt. % of b) ii) said at least one cycloaliphatic primary diamine.

In an alternative embodiment, the second component is further characterized by comprising, based on the total weight of polyamines in said second component:
from 5 to 50 wt. %, preferably from 20 to 50 wt. % of b) i) meta-xylenediamine (MXDA);
from 50 to 95 wt. %, preferably from 50 to 80 wt. % of b) iii) said at least one aliphatic primary diamine compound, which compound further comprises one or more secondary amine groups.

In another alternative embodiment, the second component is further characterized by comprising, based on the total weight of polyamines in said second component:
from 5 to 50 wt. %, preferably from 20 to 50 wt. % of b) i) meta-xylenediamine (MXDA);
from 25 to 90 wt. %, preferably from 25 to 40 wt. % of b) ii) said at least one cycloaliphatic primary diamine; and,
from 25 to 90 wt. %, preferably from 25 to 40 wt. % of b) iii) said at least one aliphatic primary diamine compound, which compound further comprises one or more secondary amine groups.

Subject to meeting the aforementioned equivalence of active hydrogen to epoxide groups, it is not precluded that the curative component further comprises b) iv) at least one further polyamine having at least two amine hydrogens reactive toward epoxide groups. For completeness, said further polyamine (b) iv)) is distinct from compounds b)i) to b)iii) as described above. Said at least one polyamine b)iv) having at least two amine hydrogens reactive toward epoxide groups should, in particular, contain primary and/or secondary amine groups and have an amine hydrogen equivalent weight of not more than 150 g/eq., preferably not more than 125 g/eq and more preferably not more than 100 g/eq.

Exemplary further polyamines b) iv), which may be used alone or in combination, include but are not limited to the following:
i) Aliphatic primary diamines of which the following examples may be mentioned. 2,2-dimethyl-1,3-propanediamine; 1,3-pentanediamine (DAMP); 1,5-pentanediamine; 1,5-diamino-2-methylpentane (MPMD); 2-butyl-2-ethyl-1,5-pentanediamine (C11-neodiamine); 1,6-hexanediamine (hexamethylenediamine, HMDA); 2,5-dimethyl-1,6-hexanediamine; 2,2,4- and/or 2,4,4-trimethylhexamethylenediamine; 1,7-heptanediamine; 1,8-octanediamine; 1,9-nonanediamine; 1,10-decanediamine; 1,11-undecanediamine; 1,12-dodecanediamine;
ii) Tertiary amine group-containing polyamines with two or three primary aliphatic amine groups of which the following specific examples may be mentioned: N,N′-bis(aminopropyl)-piperazine; tris(3-aminopropyl)amine; and, the products from the double cyanoethylation and subsequent reduction of fatty amines derived from natural fatty acids, such as and N,N-bis(3-aminopropyl)tallow alkylamine, commercially available as Triameen® Y12D and Triameen® YT (from Akzo Nobel).
iii) Ether group-containing aliphatic primary polyamines of which the following specific examples may be mentioned: bis(2-aminoethyl)ether; 3,6-dioxaoctane-1,8-diamine; 4,7-dioxadecane-1,10-diamine; 4,9-dioxadodecane-1,12-diamine; 4,7,10-trioxatridecane-1,13-diamine and higher oligomers of these diamines; bis(3-aminopropyl)polytetrahydrofuranes and other polytetrahydrofuran diamines; cycloaliphatic ether group-containing diamines obtained from the propoxylation and subsequent amination of 1,4-dimethylolcyclohexane, such as that material commercially available as Jeffamine® RFD-270 (from Huntsman); polyoxyalkylenedi- or -triamines obtainable as products from the amination of polyoxyalkylenedi- and -triols and which are commercially available under the name of Jeffamine® (from Huntsman), under the name of polyetheramine (from BASF) or under the name of PC Amines® (from Nitroil). A particular preference may be noted for the use of Jeffamine® D-230, Jeffamine® D-400, Jeffamine® D-600, Jeffamine® D-2000, Jeffamine® D-4000, Jeffamine® T-403, Jeffamine® T-3000, Jeffamine® T-5000, Jeffamine® EDR-104, Jeffamine® EDR-148 and Jeffamine® EDR-176, as well as corresponding amines from BASF or Nitroil.
iv) Polyamines with one primary and at least one secondary amino group of which the following examples may be mentioned: N-butyl-1,2-ethanediamine; 4-aminomethyl-piperidine; N-methyl-1,3-propanediamine; N-cyclohexyl-1,3-propanediamine; products from the Michael-type addition reaction of primary aliphatic diamines with acrylonitrile, maleic or fumaric acid diesters, citraconic acid diesters, acrylic and methacrylic acid esters, acrylic and methacrylic acid amides and itaconic acid diesters, reacted in a 1:1 molar ratio; products from the partial reductive alkylation of primary polyamines with aldehydes or ketones, especially N-monoalkylation products of the previously mentioned polyamines with two primary amine groups and in particular of 1,6-hexanediamine, 1,5-diamino-2-methylpentane, 1,3-bis(aminomethyl)cyclohexane, 1,4-bis(aminomethyl)cyclohexane, 1,3-bis(aminomethyl)benzene, BHMT, DETA, TETA, TEPA, DPTA, N3-amine and N4-amine, wherein preferred alkyl groups are benzyl, isobutyl, hexyl and 2-ethylhexyl; and, partially styrenated polyamines such as those commercially available as Gaskamine® 240 (from Mitsubishi Gas Chemical).
v) Secondary diamines and, in particular, N,N′-dialkylation products of the previously mentioned polyamines with two primary amine groups, especially N,N′-dialkylation products of 1,6-hexanediamine, 1,5-diamino-2-methylpentane, 1,3-bis(aminomethyl)cyclohexane, 1,4-bis(aminomethyl)-cyclohexane, 1,3-bis(aminomethyl)benzene, BHMT, DETA, TETA, TEPA, DPTA, N3-amine or N4-amine, wherein preferred alkyl groups are 2-phenylethyl, benzyl, isobutyl, hexyl and 2-ethylhexyl.
vi) Aromatic polyamines of which mention may be made of: mixtures of 3,5-dimethylthio-2,4- and -2,6-tolylenediamine (available as Ethacure® 300 from Albermarle); mixtures of 3,5-diethyl-2,4- and -2,6-tolylene diamine (DETDA); 3,3′,5,5′-tetraethyl-4,4′-diaminodiphenylmethane (M-DEA); 3,3′,5,5′-tetraethyl-2,2′-dichloro-4,4′-diaminodiphenylmethane (M-CDEA); 4,4′-diamino diphenyl-sulfone (DDS); 4-amino-N-(4-aminophenyl)benzenesulfonamide; 1,3-propylene-bis(4-aminobenzoate); 1,4-butylene-bis(4-aminobenzoate); polytetramethylene oxide-bis(4-aminobenzoate) (available as Versalink® from Air Products); 1,2-bis(2-aminophenylthio)ethane, 2-methylpropyl-(4-chloro-3,5-diaminobenzoate); and, tert.butyl-(4-chloro-3,5-diaminobenzoate).
vii) Polyamidoamines of which indicative members include the reaction products of monohydric or polyhydric carboxylic acids or the esters or anhydrides thereof,—in particular dimer fatty acids—and an aliphatic, cycloaliphatic or aromatic polyamine, for instance polyalkyleneamines such as DETA or TETA. Commercially available polyamidoamines include: Versamid® 100, 125, 140 and 150 (from Cognis); Aradur® 223, 250 and 848 (from Huntsman); Euretek® 3607 and 530 (from Huntsman); and, Beckopox® EH 651, EH 654, EH 655, EH 661 and EH 663 (from Cytec).

When present in the polyamine mixture, the supplementary polyamines b) iv) should provide less than 25% and preferably less than 20% or less than 10% of the total number of amine hydrogen atoms thereof.

### c) Phenolic Aldehyde Resin

The second component of the present composition also comprises: c) at least one phenolic aldehyde resin obtained by reacting at least one phenolic compound and at least one aldehyde having the general formula R^{a}—(CHO)_{b}, wherein:
R^{a} is H, C₁-C₁₈ alkyl, C₂-C₁₈ alkenyl, C₆-C₁₈ aryl, C₇-C₁₈ alkylaryl or C₇-C₁₈ aralkyl; and,
b is 1 or 2.

The composition should preferably comprise from 5 to 30 wt. %, preferably from 10 to 25 wt. % of c) said least one phenolic aldehyde resin, based on the weight of the composition.

As regards said reactant aldehyde(s), it is preferred that: R^{a} is H, C₁-C₁₂ alkyl, C₂-C₁₂ alkenyl, C₆-C₁₈ aryl, C₇-C₁₈ alkylaryl or C₇-C₁₈ aralkyl; and, b is 1 or 2. It is particularly preferred that: R^{a} is H or C₁-C₈ alkyl or C₂-C₈ alkenyl; and, b is 1 or 2. A more particular preference may be acknowledged for that selection wherein: R^{a} is H or C₁-C₄ alkyl or C₂-C₄ alkenyl; and, b is 1.

Exemplary reactant aldehydes, which may be reacted alone or in combination include: formaldehyde; acetaldehyde; propionaldehyde; butyraldehyde; prop-2-enal; (2E)-but-2-enal; ethanedial; 1,3-propanedial; 1,5-pentandial; benzaldehyde; and, 4-methylbenzaldehyde. A particular preference for the use of formaldehyde may be noted.

The use of natural lignins and tannins as said at least one phenolic compound is not precluded. It is preferred, however, that said least one phenolic compound is selected from the group consisting of: phenol; hydroxy phenols; C₁-C₆ alkoxyphenols; C₁-C₁₂ alkyl phenols; phenyl phenols; hydroxy group containing polyphenylmethanes; and, hydroxynaphthalenes. A particular preference may be mentioned for the use of phenol as either one reactant phenolic compound or, more desirably, the sole reactant phenolic compound from which the phenolic aldehyde resin is obtained.

Exemplary hydroxy phenols are phenols substituted with one or more hydroxyl groups, including but not limited to resorcinol (benzene-1,3-diol), C₁-C₆ alkylresorcinol; catechol (benzene-1,2-diol), C₁-C₆ alkylcatechols and hydroquinone (benzene-1,4-diol). Illustrative C₁-C₆ alkoxyphenols are 2-methoxyphenol, 3-methoxyphenol, 4-methoxyphenol, 2-ethoxyphenol and 4-ethoxyphenol. Exemplary C₁-C₁₂ alkyl phenols are 2-methylphenol, 3-methylphenol, 4-methylphenol, 2,3-dimethylphenol, 2,4-dimethylphenol, 2,5-dimethylphenol, 2,6-dimethylphenol, 3,4-dimethylphenol, 3,5-dimethylphenol, 4-tert-butylphenol, 4-iso-octylphenol and 4-nonylphenol. Exemplary phenyl phenols are 2-phenylphenol and 4-phenylphenol. Illustrative hydroxyl group containing polyphenylmethanes will generally have from 1 to 4 hydroxyl groups and include, in particular, bisphenols such as bisphenol A, bisphenol AF, bisphenol B, bisphenol BP, bisphenol C, bisphenol C2, bisphenol E, bisphenol F, bisphenol G, bisphenol PH, bisphenol TMC, bisphenol Z, bisphenol M, bisphenol S, bisphenol P and bisphenol FL. Exemplary hydroxyl naphthalenes are 1-hydroxy naphthalene and 2-hydroxy naphthalene.

There is no particular intention to limit the conditions under which said at least one phenolic compound and at least one aldehyde are reacted. It is however preferred that said reaction occurs under basic conditions and subject to the employment of a stoichiometric excess of aldehyde groups (—CHO) to hydroxyl (—OH) groups. In this embodiment, the ratio of aldehyde groups to hydroxyl groups should preferably be in the range from 1.1:1 to 5:1, for example from 1.1:1 to 3:1.

Basic reaction conditions are established by adding a catalytic amount of a basic compound to the reactants. Suitable amounts of the basic catalyst may be determined by the person or ordinary skill in the art: that amount can be added initially to the reactants or the catalyst can be added in increments or continuously over a defined time period. And exemplary basic catalysts include: alkali metal hydroxides such as lithium hydroxide, sodium hydroxide and potassium hydroxide; alkali earth metal hydroxides such as calcium hydroxide; alkali metal carbonates such as sodium carbonate and potassium carbonate; alkaline earth metal carbonates; and, amines.

For inclusion in the composition of the present invention, it is preferred that said at least one phenolic aldehyde resin has, based on the weight of the resin: a free aldehyde content of less than 1 wt. %; and, a free phenolic compound content of less than 1 wt. %. More preferably said least one phenolic aldehyde resin should be substantially free of free aldehyde and of free phenolic compounds. The terms “free phenolic compound” and “free aldehyde” refers, respectively, to phenolic compound(s) or aldehyde(s) which are not bound within the resin and which can thus evaporate from the resin. The amount of residual phenolic compound may be determined according to the method described in DIN EN ISO 8974:2002-09.

### Additives and Adjunct Ingredients

Said compositions obtained in the present invention will typically further comprise adjuvants and additives that can impart improved properties to these compositions. For instance, the adjuvants and additives may impart one or more of: improved elastic properties; improved elastic recovery; faster curing time; and, lower residual tack. Included among such adjuvants and additives—which independently of one another may be included in single components or both components of a two component (2K) composition—are: catalysts; plasticizers; stabilizers including UV stabilizers; antioxidants; tougheners; fillers; drying agents; adhesion promoters; fungicides; flame retardants; rheological adjuvants; color pastes or color pigments, such as titanium dioxide, iron oxides or carbon black; solvents; and/or, non-reactive diluents.

For completeness, it is noted that in general adjunct materials and additives which contain epoxide-reactive groups will be blended into the hardener component of the two component (2K) composition. Materials that contain epoxide groups or which are reactive with the hardener(s) are generally formulated into the epoxide-containing component of a two component (2K) composition. Unreactive materials may be formulated into either or both of the first and second components.

Suitable catalysts are substances that promote the reaction between the epoxide groups and the amine groups. Without intention to the limit the catalysts used in the present invention, mention may be made of the following suitable catalysts: i) acids or compounds hydrolyzable to acids, in particular a) organic carboxylic acids, such as acetic acid, benzoic acid, salicylic acid, 2-nitrobenzoic acid and lactic acid; b) organic sulfonic acids, such as methanesulfonic acid, p-toluenesulfonic acid and 4-dodecylbenzenesulfonic acid; c) sulfonic acid esters; d) inorganic acids, such as phosphoric acid; e) Lewis acid compounds, such as BF3 amine complexes, SbF6 sulfonium compounds, bis-arene iron complexes; f) Bronsted acid compounds, such as pentafluoroantimonic acid complexes; and, e) mixtures of the aforementioned acids and acid esters; ii) tertiary amines, such as 1,4-diazabicyclo[2.2.2]octane, benzyldimethylamine, α-methylbenzyl dimethylamine, triethanolamine, dimethylamino propylamine, imidazoles—including N-methylimidazole, N-vinylimidazole and 1,2-dimethylimidazole—and salts of such tertiary amines; iii) quaternary ammonium salts, such as benzyltrimethyl ammonium chloride; iv) amidines, such as 1,8-diazabicyclo[5.4.0]undec-7-ene; v) guanidines, such as 1,1,3,3-tetramethylguanidine; vi) bisphenols; vii) phenol resins; viii) Mannich bases; and, ix) phosphites, such as di- and triphenylphosphites.

A “plasticizer” for the purposes of this invention is a substance that decreases the viscosity of the composition and thus facilitates its processability. Herein the plasticizer may constitute up to 10 wt. % or up to 5 wt. %, based on the total weight of the composition, and is preferably selected from the group consisting of: polydimethylsiloxanes (PDMS); diurethanes; ethers of monofunctional, linear or branched C4-C16 alcohols, such as Cetiol OE (obtainable from Cognis Deutschland GmbH, Dusseldorf); esters of abietic acid, butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; epoxidized plasticizers; polyether plasticizers, such as end-capped polyethylene or polypropylene glycols; polystyrene; hydrocarbon plasticizers; chlorinated paraffin; and, mixtures thereof. It is noted that, in principle, phthalic acid esters can be used as the plasticizer but these are not preferred due to their toxicological potential. It is preferred that the plasticizer comprises or consists of one or more polydimethylsiloxane (PDMS).

“Stabilizers” for purposes of this invention are to be understood as antioxidants, UV stabilizers or hydrolysis stabilizers. Herein stabilizers may constitute in toto up to 10 wt. % or up to 5 wt. %, based on the total weight of the composition. Standard commercial examples of stabilizers suitable for use herein include: sterically hindered phenols; thioethers; benzotriazoles; benzophenones; benzoates; cyanoacrylates; acrylates; amines of the hindered amine light stabilizer (HALS) type; phosphorus; sulfur; and, mixtures thereof.

The compositions of the present invention may optionally contain a toughening rubber in the form of in the form of core-shell particles dispersed in the epoxy resin matrix. The term “core shell rubber” or CSR is being employed in accordance with its standard meaning in the art as denoting a rubber particle core formed by a polymer comprising an elastomeric or rubbery polymer as a main ingredient and a shell layer formed by a polymer which is graft polymerized onto the core. The shell layer partially or entirely covers the surface of the rubber particle core in the graft polymerization process. By weight, the core should constitute at least 50 wt. % of the core-shell rubber particle. The polymeric material of the core should have a glass transition temperature (T_{g}) of no greater than 0° C. and preferably a glass transition temperature (T_{g}) of −20° C. or lower, more preferably −40° C. or lower and even more preferably −60° C. or lower. The polymer of the shell is non-elastomeric, thermoplastic or thermoset polymer having a glass transition temperature (T_{g}) of greater than room temperature, preferably greater than 30° C. and more preferably greater than 50° C.

Without intention to limit the invention, the core may be comprised of: a diene homopolymer, for example, a homopolymer of butadiene or isoprene; a diene copolymer, for example a copolymer of butadiene or isoprene with one or more ethylenically unsaturated monomers, such as vinyl aromatic monomers, (meth)acrylonitrile or (meth)acrylates; polymers based on (meth)acrylic acid ester monomers, such as polybutylacrylate; and, polysiloxane elastomers such as polydimethylsiloxane and crosslinked polydimethylsiloxane.

Similarly without intention to limit the present invention, the shell may be comprised of a polymer or copolymer of one or more monomers selected from: (meth)acrylates, such as methyl methacrylate; vinyl aromatic monomers, such as styrene; vinyl cyanides, such as acrylonitrile; unsaturated acids and anhydrides, such as acrylic acid; and, (meth)acrylamides. The polymer or copolymer used in the shell may possess acid groups that are cross-linked ionically through metal carboxylate formation, in particular through forming salts of divalent metal cations. The shell polymer or copolymer may also be covalently cross-linked by monomers having two or more double bonds per molecule.

It is preferred that any included core-shell rubber particles have an average particle size (d50) of from 10 nm to 300 nm, for example from 50 nm to 200 nm: said particle size refers to the diameter or largest dimension of a particle in a distribution of particles and is measured via dynamic light scattering.

The present application does not preclude the presence of two types of core shell rubber (CSR) particles with different particle sizes in the composition to provide a balance of key properties of the resultant cured product, including shear strength, peel strength and resin fracture toughness. In this embodiment, smaller included particles (1^{st} CSR type) may have an average particle size of from 10 to 100 nm and larger included particles (2^{nd} CSR type) may have an average particle size of from 120 nm to 300 nm, for example from 150 to 300 nm. The smaller core shell rubber particles should typically be employed in excess of the larger particles on a weight basis: a weight ratio of smaller CSR particles to larger CSR particles of from 3:1 to 5:1 may be employed for instance.

The core-shell rubber may be selected from commercially available products, examples of which include: Paraloid EXL 2650A, EXL 2655 and EXL2691 A, available from The Dow Chemical Company; the Kane Ace® MX series available from Kaneka Corporation, and in particular MX 120, MX 125, MX 130, MX 136, MX 551, MX553; and, METABLEN SX-006 available from Mitsubishi Rayon.

The core shell rubber particles should be included in the composition in an amount of from 0 to 10 wt. %, for example from 0 to 5 wt. % based on the total weight of the composition.

As noted, the compositions according to the present invention can additionally contain fillers. Suitable here are, for example, chalk, lime powder, precipitated and/or pyrogenic silicic acid, zeolites, bentonites, magnesium carbonate, diatomite, alumina, clay, talc, titanium oxide, iron oxide, zinc oxide, sand, quartz, flint, mica, glass powder, and other ground mineral substances. Organic fillers can also be used, in particular carbon black, graphite, wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added. Aluminum powder is likewise suitable as a filler.

Also suitable as fillers are hollow spheres having a mineral shell or a plastic shell. These can be, for example, hollow glass spheres that are obtainable commercially under the trade names Glass Bubbles®. Plastic-based hollow spheres, such as Expancel® or Dualite®, may be used and are described in EP 0 520 426 B1: they are made up of inorganic or organic substances and each have a diameter of 1 mm or less, preferably 500 μm or less.

Fillers which impart thixotropy to the composition may be preferred for many applications: such fillers are also described as rheological adjuvants, e.g. hydrogenated castor oil, fatty acid amides, or swellable plastics such as PVC.

The total amount of fillers present in the compositions of the present invention will preferably be from 0 to 30 wt. %, and more preferably from 0 to 20 wt. %, based on the total weight of the composition. The desired viscosity of the curable composition will typically be determinative of the total amount of filler added and it is submitted that in order to be readily extrudable out of a suitable dispensing apparatus—such as a tube—the curable compositions should possess a viscosity of from 3000 to 150,000, preferably from 40,000 to 80,000 mPas, or even from 50,000 to 60,000 mPas.

It is noted that compounds having metal chelating properties may be used in the compositions of the present invention to help enhance the adhesion of the cured adhesive to a substrate surface. Further, also suitable for use as adhesion promoters are the acetoacetate-functionalized modifying resins sold by King Industries under the trade name K-FLEX XM-B301.

In order to enhance shelf life even further, it is often advisable to further stabilize the compositions of the present invention with respect to moisture penetration through using drying agents. A need also occasionally exists to lower the viscosity of a composition according to the present invention for specific applications, by using reactive diluent(s). The total amount of reactive diluents present will typically be up to 10 wt. %, and preferably from 1 to 5 wt. %, based on the total weight of the composition.

The presence of solvents and non-reactive diluents in the compositions of the present invention is also not precluded where this can usefully moderate the viscosities thereof. For instance, but for illustration only, the compositions may contain one or more of: xylene; 2-methoxyethanol; dimethoxyethanol; 2-ethoxyethanol; 2-propoxyethanol; 2-isopropoxyethanol; 2-butoxyethanol; 2-phenoxyethanol; 2-benzyloxyethanol; benzyl alcohol; ethylene glycol; ethylene glycol dimethyl ether; ethylene glycol diethyl ether; ethylene glycol dibutyl ether; ethylene glycol diphenyl ether; diethylene glycol; diethylene glycol-monomethyl ether; diethylene glycol-monoethyl ether; diethylene glycol-mono-n-butyl ether; diethylene glycol dimethyl ether; diethylene glycol diethyl ether; diethylene glycoldi-n-butylyl ether; propylene glycol butyl ether; propylene glycol phenyl ether; dipropylene glycol; dipropylene glycol monomethyl ether; dipropylene glycol dimethyl ether; dipropylene glycoldi-n-butyl ether; N-methylpyrrolidone; diphenylmethane; diisopropylnaphthalene; petroleum fractions such as Solvesso® products (available from Exxon); alkylphenols, such as tert-butylphenol, nonylphenol, dodecylphenol and 8,11,14-pentadecatrienylphenol; styrenated phenol; bisphenols; aromatic hydrocarbon resins especially those containing phenol groups, such as ethoxylated or propoxylated phenols; adipates; sebacates; phthalates; benzoates; organic phosphoric or sulfonic acid esters; and sulfonamides.

The above aside, it is preferred that said solvents and non-reactive diluents constitute in toto less than 10 wt. %, in particular less than 5 wt. % or less than 2 wt. %, based on the total weight of the composition.

### Illustrative Embodiment of the Two Component Composition

In an exemplary embodiment of the present invention, the two component (2K) composition comprises, based on the weight of the composition:
a first component comprising:
   from 20 to 60 wt. % of a) at least one diepoxide compound selected from the group consisting of: bisphenol A based diglycidylethers; hydrogenated bisphenol A based diglycidylethers; bisphenol F diglycidyl ethers; and, hydrogenated bisphenol F based diglycidylethers; and,
a second component comprising:
   b) a mixture of polyamines of which each polyamine has at least two amine hydrogens reactive toward epoxide groups, said mixture comprising:
      b) i) meta-xylenediamine (MXDA); and,
      b) ii) at least one cycloaliphatic primary diamine having an amine hydrogen equivalent weight of not more than 150 g/eq; and/or,
      b) iii) at least one aliphatic primary diamine compound selected from the group consisting of: 3-(2-aminoethyl)aminopropylamine; triethylenetetramine (TETA); tetraethylenepentamine (TEPA); and, pentaethylenehexamine (PEHA); and,
   from 5 to 30 wt. % of c) at least one phenolic aldehyde resin obtained by reacting at least one phenolic compound and at least one aldehyde having the general formula R^{a}—(CHO)_{b}, wherein:
      R^{a} is H, C₁-C₈alkyl or C₂-C₈ alkenyl; and,
      b is 1 or 2,
wherein said curable composition is characterized by a stoichiometric ratio of the amine hydrogen atoms of said second component to the epoxy groups of said first component (a) of from 0.5:1 to 1.2:1, preferably from 0.8:1 to 1.0:1.

In a further exemplary embodiment of the present invention, the two component (2K) composition comprises, based on the weight of the composition:
a first component comprising:
   from 20 to 60 wt. % of a) at least one diepoxide compound selected from the group consisting of: bisphenol A based diglycidylethers; hydrogenated bisphenol A based diglycidylethers; bisphenol F diglycidyl ethers; and, hydrogenated bisphenol F based diglycidylethers; and,
a second component comprising:
   b) a mixture of polyamines of which each polyamine has at least two amine hydrogens reactive toward epoxide groups, said mixture comprising:
      b) i) meta-xylenediamine (MXDA); and,
      b) ii) at least one cycloaliphatic primary diamine having an amine hydrogen equivalent weight of not more than 150 g/eq; and/or,
      b) iii) triethylenetetramine (TETA); and,
   from 5 to 30 wt. % of c) at least one phenolic aldehyde resin obtained by reacting phenol and at least one aldehyde having the general formula R^{a}—(CHO)_{b}, wherein:
      R^{a} is H, C₁-C₄ alkyl or C₂-C₄ alkenyl; and,
      b is 1,
wherein said curable composition is characterized by a stoichiometric ratio of the amine hydrogen atoms of said second component to the epoxy groups of said first component (a) of from 0.5:1 to 1.2:1, preferably from 0.8:1 to 1.0:1.

### Methods and Applications

For the two component (2K) curable compositions, the reactive components are brought together and mixed in such a manner as to induce the hardening thereof: the reactive compounds should be mixed under sufficient shear force to yield a homogeneous mixture. It is considered that this can be achieved without special conditions or special equipment. That said, suitable mixing devices might include: static mixing devices; magnetic stir bar apparatuses; wire whisk devices; augers; batch mixers; planetary mixers; C. W. Brabender or Banburry® style mixers; and, high shear mixers, such as blade-style blenders and rotary impellers.

For small-scale liner applications in which volumes of less than 2 liters will generally be used, the preferred packaging for the two component (2K) compositions will be side-by-side double cartridges or coaxial cartridges, in which two tubular chambers are arranged alongside one another or inside one another and are sealed with pistons: the driving of these pistons allows the components to be extruded from the cartridge, advantageously through a closely mounted static or dynamic mixer. For larger volume applications, the two components of the composition may advantageously be stored in drums or pails: in this case the two components are extruded via hydraulic presses, in particular by way of follower plates, and are supplied via pipelines to a mixing apparatus which can ensure fine and highly homogeneous mixing of the hardener and binder components. In any event, for any package it is important that the binder component be disposed with an airtight and moisture-tight seal, so that both components can be stored for a long time, ideally for 12 months or longer.

Non-limiting examples of two component dispensing apparatuses and methods that may be suitable for the present invention include those described in U.S. Pat. Nos. 6,129,244 and 8,313,006.

The two (2K) component curable compositions should broadly be formulated to exhibit an initial viscosity—determined immediately after mixing, for example, up to two minutes after mixing—of less than 200000 mPa-s, for instance less than 100000 mPa·s, at 25° C. Independently of or additional to said viscosity characteristics, the two (2K) component composition should be formulated to be bubble (foam) free upon mixing and subsequent curing.

The curing of the compositions of the invention can occur at temperatures in the range of from −10° C. to 150° C., preferably from 0° C. to 120° C., and in particular from 20° C. to 120° C. The temperature that is suitable depends on the specific compounds present and the desired curing rate and can be determined in the individual case by the skilled artisan, using simple preliminary tests if necessary. Of course, curing at temperatures of from 10° C. to 35° C. or from 20° C. to 30° C. is especially advantageous as it obviates the requirement to substantially heat or cool the mixture from the usually prevailing ambient temperature. Where applicable, however, the temperature of the mixture formed from the respective components of a two (2K) component composition may be raised above the mixing temperature and/or the application temperature using conventional means including microwave induction.

The curable compositions according to the invention may find utility inter alia in: varnishes; inks; binding agents for fibers and/or particles; the coating of glass; the coating of mineral building materials, such as lime- and/or cement-bonded plasters, gypsum-containing surfaces, fiber cement building materials and concrete; the coating and sealing of wood and wooden materials, such as chipboard, fiber board and paper; the coating of metallic surfaces; the coating of asphalt- and bitumen-containing pavements; the coating and sealing of various plastic surfaces; and, the coating of leather and textiles.

It is also considered that the compositions of the present invention are suitable as pourable sealants for electrical building components such as cables, fiber optics, cover strips or plugs. The sealants may serve to protect those components against the ingress of water and other contaminants, against heat exposure, temperature fluctuation and thermal shock, and against mechanical damage.

By virtue of the fact that the compositions of the present invention are capable of creating a high bonding strength in a short time, often at room temperature, the compositions are optimally used for forming composite structures by surface-to-surface bonding of the same or different materials to one another. The binding together of wood and wooden materials and the binding together of metallic materials may be mentioned as exemplary adhesive applications of the present compositions.

In each of the above described applications, the compositions may applied by conventional application methods such as: brushing; roll coating; doctor-blade application; printing methods; and, spraying methods, including but not limited to air-atomized spray, air-assisted spray, airless spray and high-volume low-pressure spray. For coating and adhesive applications, it is recommended that the compositions be applied to a wet film thickness of from 10 to 500 μm. The application of thinner layers within this range is more economical and provides for a reduced likelihood of thick cured regions that may—for coating applications—require sanding. However, great control must be exercised in applying thinner coatings or layers so as to avoid the formation of discontinuous cured films.

For completeness, it is noted that the present invention does not preclude the preparation of epoxy adhesives in the form of “film adhesive”. A pre-polymer mixture of epoxy resins, hardener, and other desired ingredients is applied as a coating onto a polymer film substrate, rolled up and stored at a sufficiently low temperature to inhibit the chemical reactions between the components. When needed, the film adhesive is removed from the low temperature environment and applied to a metal or composite part, the backing is stripped off and the assembly completed and cured in an oven or autoclave.

Various features and embodiments of the disclosure are described in the following examples, which are intended to be representative and not limiting.

### EXAMPLES

The following commercial products were used in the Examples:
DER 356: Reaction product of bisphenol-A and bisphenol-F with epichlorohydrin, available from Olin.
BB-AMIDE 5033: Medium-low viscosity reactive polyamide resin (AHEW 95-110 g/eq.) available from BB Resins S.r.l.
BB-Amine 3004: Amino-functional bisphenol-A, available from BB Resins S.r.l.
Hard D140G: Medium-low viscosity reactive polyamide resin (AHEW 95-110 g/eq.) available from BB Resins S.r.l.
DCH99: Cyclohexane-1,2-diamine available from Huntsman.
Amicure PACM: bis-(p-aminocyclohexyl) methane, available from Evonik Operations GmbH.
Ancamine 1916: Phenol-free amine adduct (AHEW 43 g/eq.) available from Evonik Operations GmbH.
Ancamine 2280: Low-viscosity modified cycloaliphatic amine (AHEW) available from Evonik Operations GmbH.
Ancamine 2914UF: Blend of aliphatic amines (AHEW 95 g/eq.) available from Evonik Operations GmbH.
Ancamine 2432: Blend of meta-xylene diamine and phenol-formaldehyde resin (AHEW 88 g/eq.) available from Evonik Operations GmbH.
Omicure 24 EMI: 2-ethyl-4-methyl imidazole, available from Huntsman.
Aradur 33641: Blend of meta-xylene diamine and phenol-formaldehyde resin (AHEW 58 g/eq.) available from Huntsman.
Triethylenetetramine: Polyamine having primary and secondary amine groups, (AHEW 24 g/eq.) available from Dow Chemical.
Genamid 490: Liquid amidoamine (AHEW 95 g/eq.) available from Cognis.
Novares LS 500: Aromatic hydrocarbon resin, tackifier available from Rutgers Chemicals.
Silquest™ A-187: Epoxy functional silane available from Momentive Performance Materials.
Silanol A1120: N-(2-aminoethyl)-3-aminopropyltrimethoxysilane, available from Uniquechem Solutions Inc.

The above described ingredients were used to prepare the formulations given in Tables 1 and 3 below. The weight percentages (wt. %) given in those Tables are based on the weight of each component of the composition.

The following test methods were then used to characterize the two-component formulations:
Viscosity: The initial viscosity of the freshly mixed composition (1^{st} plus 2^{nd} components) was calculated based on the viscosities of the contained components (1^{st}, 2^{nd}) and their content ratios.

Pot Life: Broadly, “pot life” references the time period in which a composition is sufficiently liquid such that it may be applied to a substrate material. The “pot-life” of this disclosure specifically refers to the measured time it takes for the viscosity of the composition (400 g) to increase to 10 times the initial calculated viscosity of the composition. By way of example, if the initial viscosity of a composition upon mixing of the two components (1^{st}, 2^{nd}) is 100 cPs, then the pot life of the composition would be the amount of time it takes for the composition to reach a viscosity of 1000 cPs.

Tensile Lap Shear (TLS) Test: The substrate was stainless steel (1.4301) having a thickness of 0.1 inch. The substrate was cut into 2.5 cm×10 cm (1″×4″) in size for tensile testing. Tensile lap shear (TLS) test was performed at room temperature based upon ASTM D3163-01 Standard Test Method for Determining Strength of Adhesively Bonded Rigid Plastic Lap-Shear Joints in Shear by Tension Loading. The bond overlapping area for each stated substrate was 2.5 cm×1.3 cm (1″1″) with a bond thickness of 0.1 cm (40 mil). The applied two-component (2K) adhesive compositions were cured in the overlapping region under two regimes: a) storage of the bonded structures for 24 hours at room temperature followed by the application of a temperature of 100° C. for 30 minutes prior to initial tensile testing; and, b) storage of the bonded structures at room temperature for 7 days (168 hours) prior to initial tensile testing.

Shore Hardness: Sample disks were prepared by mixing the ingredients of the composition (Table 1) at room temperature in a polypropylene (PP) vial and further homogenizing the mixture in a planetary mixer (Speed Mixer: 800 rpm; 30 seconds; ambient pressure). The vials were then subjected to one of the two curing regimes mentioned above, specifically either: a) storage of the bonded structures for 24 hours at room temperature followed by the application of a temperature of 100° C. for 30 minutes; and, b) storage of the bonded structures at room temperature for 7 days (168 hours). The Shore hardness was determined by pressing a hand-held durometer (Zwick 3131) onto the sample (≥6 mm thickness; 3 seconds contact time before measurement) in accordance with DIN ISO 7619-1. The hardness was recorded after 30 minutes (conditions a))—thereby after the initial curing conditions (30 minutes, 100° C.) if applicable—or after 7 days (conditions b)) and further monitored every 30 minutes upon storage under room temperature and pressure. Another data point (Final Hardness) was recorded after 24 hours of storage at room temperature.

Glass Transition Temperature (Tq, ° C.): The glass transition temperature is the onset temperature at which the cured resin changes from a glassy (solid) state to a soft, rubbery state: it can be considered the point at which a measurable reduction in physical properties occurs resulting from exposure to elevated temperatures. Herein the glass transition temperature is reported on second heating: the cured sample is exposed to a first heating schedule from room temperature to 200° C. at a rate of 10° C. per minutes, cooled and then subjected to a second heating using the same heating schedule. A Differential Scanning Calorimeter (DSC) is used to measures the heat flow in and out of a sample to determine its Tg on said second heating. This test is conducted by placing a fully cured sample into a small pan in the DSC and heating it according to the given schedule. The heat flow into the sample is measured and compared to an empty reference pan. The difference in heat flow is measured and plotted, with the onset of the inflection occurring in the plotted curve being recorded as the Tg.

Abrasion Resistance (Miller) Test: This test was performed in accordance with ASTM G75. In this test, clays are mixed with water to create a flowing slurry that is contacted with a coating of the composition applied to a stainless steel test piece.

Boeing Flow Test: The degree of slump of the cured composition when applied to a vertical joint was tested in accordance with ASTM D2202 Standard Test Method for Slump of Sealants.

Hazard Statements (H-Statements): These statements are part of the Globally Harmonized System of Classification and Labeling of Chemicals (GHS). For the exemplary compositions, evaluated health hazards (H3xx) include: H302, harmful if swallowed; H314, causes severe skin burns and eye damage; H317, may cause an allergic skin reaction; H318, causes serious eye damage; H331, toxic if inhaled; H332, harmful if inhaled; H335, may cause respiratory irritation; H360, may damage fertility or unborn child; H360d, may damage unborn child; H360Fd, may damage fertility and may damage the unborn child; and, H373, damage to organs through repeated or prolonged exposure. For the exemplary compositions, evaluated environmental hazards (H4xx) include: H412, Harmful to aquatic life. Reference may be made to https://www.msds-europe.com/wp-content/uploads/2020/10/Hazard-statement.pdf.

### Experiment 1

Two-component formulations were prepared in accordance with Table 1 hereinbelow: Reference Example 1 represents a known commercial product. The weight percentages (wt. %) given are based on the total weight of each component.

TABLE 1

| | Reference | |
|---|---|---|
| | Example | Example 1 |
| Material Description | (wt. %) | (wt. %) |
| First Component (A) | | |
| DER 356 | 29.0 | 29.0 |
| Fillers | 68.0 | 68.0 |
| Silquest A187 | 0.5 | 0.5 |
| Additives | 2.5 | 2.5 |
| Second Component (B) | | |
| BB Amide 5033 H | 13.1 | 21.1 |
| Triethylenetetramine | 8.2 | 13.0 |
| Ancamine 1916 | 24.6 | |
| Aradur 33641 | | 17.8 |
| Fillers | 50.2 | 48.1 |
| Additives | 3.9 | |

For each of the formulations, the described first, resinous component and the second component were degassed under vacuum at room temperature. The components were then mixed—at the stated ratio by weight, corresponding to the desired equivalence ratio of functional groups—under stirring with a spatula.

The above described tests were performed and the results thereof are provided in Table 2 herein below.

TABLE 2

| | Reference | |
|---|---|---|
| Tested Property | Example 1 | Example 1 |
| Pot life (minutes) | 40 | 38 |
| Hardness (Shore D) | 84 | 84 |
| Tg (° C.) | 114 | 116 |
| Lap Shear Strength (MPa) | 15.4 | 12.2 |
| Cured: 3 days at room | | |
| temperature | | |
| Lap Shear Strength (MPa) | 25.1 | 25.9 |
| Cured: 3 days at room | | |
| temperature and 1 hour at 120° C. | | |
| Hazard Category 1 | H314, | H314, |
| | H317, H318 | H317, H318 |
| Hazard Category 3 | H331, H412 | H412 |
| ATE_{Mix} Oral Toxicity (mg/kg) | | >2000 |
| ATE_{Mix} Dermal Toxicity (mg/kg) | | >2000 |
| ATE_{Mix} Inhalative Toxicity (Dust/ | | >5 |
| Mist) | | |
| (mg/L) | | |

### Experiment 2

Two-component formulations were prepared in accordance with Table 3 hereinbelow: Reference Example 2 represents a known commercial product. The weight percentages (wt. %) given are based on the total weight of each component.

TABLE 3

| | Reference | Exam- | Exam- | Exam- | Exam- |
|---|---|---|---|---|---|
| Material Description | Example 2 | ple 2 | ple 3 | ple 4 | ple 5 |
| First Component (A) | | | | | |
| DER 356 | 35.0 | 35.0 | 35.0 | 35.0 | 35.0 |
| Fillers | 62.5 | 62.5 | 62.5 | 62.5 | 62.5 |
| Silquest A187 | 0.4 | 0.4 | 0.4 | 0.4 | 0.4 |
| Additives | 2.1 | 2.1 | 2.1 | 2.1 | 2.1 |
| Second Component (B) | | | | | |
| Ancamine 2280 | 73.8 | 73.8 | 64.8 | 65.3 | |
| BB Amine 3004 | 11.8 | | | | |
| Amicure PACM | 14.4 | 14.4 | 21.2 | 26.7 | 13.4 |
| DCH99 | — | 5.9 | — | — | — |
| Ancamine 2914UF | — | 5.9 | — | — | — |
| Aradur 33641 | — | — | 15.0 | 8.0 | — |
| Ancamine 2432 | — | — | — | — | 86.6 |

For each of the formulations, the described first, resinous component and the second component were degassed under vacuum at room temperature. The components were then separately loaded into individual cartridges of a twin-cartridge syringe at the stated ratio by weight, corresponding to the desired equivalence ratio of functional groups. A static mixing tip was then attached to the outlet of the syringe and the components were dispensed there through under constant pressure to ensure an even flow from both cartridges and sufficient mixing before application to the stated substrate.

The above described tests were performed and the results thereof are provided in Table 4 herein below.

TABLE 4

| | Ref- | | | | |
|---|---|---|---|---|---|
| | erence | | | | |
| | Exam- | Exam- | Exam- | Exam- | Exam- |
| Tested Property | ple 2 | ple 2 | ple 3 | ple 4 | ple 5 |
| Viscosity (Pa · s) | 0.533 | 0.277 | 0.600 | 0.499 | 0.323 |
| Pot Life (minutes) | 65 | 60 | 60 | 63 | 70 |
| Tg (° C.) | 121.6 | 124.9 | 118.1 | 121.9 | 89.3 |
| Lap Shear | 12.2 | 11.26 | — | — | — |
| Strength (MPa) | | | | | |
| Cured: 1 day at | | | | | |
| room temperature | | | | | |
| Lap Shear | 20.02 | 22.51 | 29.12 | 25.81 | 26.69 |
| Strength (MPa) | | | | | |
| Cured 1 day at | | | | | |
| room temperature | | | | | |
| and 30 minutes | | | | | |
| at 100° C. | | | | | |
| Category 1 | H314, | H314, | H314, | H314, | H314, |
| Hazard | H317, | H317, | H317, | H317, | H317, |
| | H318 | H318 | H318 | H318 | H318 |
| Category 1B | | H360Fd | | | |
| Hazard | | | | | |
| Category 2 | H373 | H360d, | H360d, | H360d, | H373 |
| Hazard | | H373 | H373 | H373 | |
| Category 3 | H331, | H335, | H412 | H412 | H412 |
| Hazard | H412 | H412 | | | |
| Category 4 | H302 | H302 | H302 | H302 | H302 |
| Hazard | | | | | |
| ATE_{Mix} Oral | 702 | | | | 999 |
| Toxicity (mg/kg) | | | | | |
| ATE_{Mix} Dermal | >2000 | | | | >2000 |
| Toxicity (mg/kg) | | | | | |
| ATE_{Mix} Inhalative | 0.8 | | | | 4.5 |
| Toxicity | | | | | |
| (Dust/Mist) | | | | | |
| (mg/L) | | | | | |

### Experiment 3

Two-component formulations were prepared in accordance with Table 5 hereinbelow. The weights given in the Table are the percentages by weight (wt. %) of each component of the two-component composition.

TABLE 5

| | Reference | | |
|---|---|---|---|
| Material Description | Example 3 | Example 6 | Example 7 |
| First Component (A) | | | |
| DER 331 | 24.1 | 24.1 | 22.6 |
| Epodil 750 | 2.0 | 2.0 | 2 |
| Silquest A187 | 0.2 | 0.2 | 0.2 |
| Fillers | 72.9 | 72.9 | 71.9 |
| Additives | 0.8 | 0.8 | 3.3 |
| Second Component | | | |
| (B) | | | |
| Hard E908 | 8.0 | | |
| Genamid 490 | 4.4 | 2.5 | 2.5 |
| Hard D140G | 4.4 | 4.5 | 4.5 |
| Silanol A1120 | 0.2 | 0.2 | 0.2 |
| Aradur 33461 | | 5.2 | 5.2 |
| TETA | | 4.6 | 4.6 |
| Fillers | 80.2 | 80.2 | 80.2 |
| Additives | 2.8 | 2.8 | 2.8 |

For each of the formulations, the described first, resinous component and the second component were degassed under vacuum at room temperature. The components were then separately loaded into individual cartridges of a twin-cartridge syringe at a 2:1 ratio by weight for the first (A) to second (B) component, corresponding to the desired equivalence ratio of functional groups. A static mixing tip was then attached to the outlet of the syringe and the components were dispensed there through under constant pressure to ensure an even flow from both cartridges and sufficient mixing before application to the stated substrate.

The above described tests were performed and the results thereof are provided in Table 6 herein below.

TABLE 6

| | Reference | | |
|---|---|---|---|
| Tested Property | Example 3 | Example 6 | Example 7 |
| Pot Life (minutes) | | 47 | 47 |
| Tg (° C.) | | 100.3 | 101.0 |
| Lap Shear Strength (MPa) | | 14.4 | 21.2 |
| Cured: 3 days at room | | | |
| temperature | | | |
| Boeing Flow Test (mm) | 2 | 2 | 2 |
| Abrasion Resistance Test | 30.7 | 40.8 | 58.3 |
| (mg/m³) | | | |
| ATE_{Mix} Oral Toxicity | ≥2000 | ≥2000 | ≥2000 |
| (mg/kg) | | | |
| ATE_{Mix} Dermal Toxicity | ≥2000 | ≥2000 | ≥2000 |
| (mg/kg) | | | |
| ATE_{Mix} Inhalative Toxicity | 1.5 | >5 | >5 |
| (Dust/Mist) | | | |
| (mg/L) | | | |

In view of the foregoing description and examples, it will be apparent to those skilled in the art that equivalent modifications thereof can be made without departing from the scope of the appended claims.

1. A two-component (2K) curable composition comprising:
a first component comprising:
a) at least one epoxy resin; and,
a second component comprising:
b) a mixture of polyamines of which each polyamine has at least two amine hydrogens reactive toward epoxide groups, said mixture comprising:
b) i) meta-xylenediamine (MXDA); and,
b) ii) at least one cycloaliphatic primary diamine; and/or,
b) iii) at least one aliphatic primary diamine compound, which compound further comprises one or more secondary amine groups; and,
c) at least one phenolic aldehyde resin obtained by reacting at least one phenolic compound and at least one aldehyde having the general formula R^{a}—(CHO)_{b}, wherein:
R^{a} is H, C₁-C₁₈ alkyl, C₂-C₁₈ alkenyl, C₆-C₁₈ aryl, C₇-C₁₈ alkylaryl or C₇-C₁₈ aralkyl; and,
b is 1 or 2,
wherein said curable composition is characterized by a stoichiometric ratio of the amine hydrogen atoms of said second component to the epoxy groups of said first component (a) of from 0.5:1 to 1.2:1.

2. The two-component (2K) composition according to claim 1, wherein said part a) comprises at least one polyepoxide compound having an epoxide equivalent weight of from 100 to 700 g/eq.

3. The two-component (2K) composition according to claim 1, wherein part a) comprises at least one polyepoxide compound selected from the group consisting of: glycidyl ethers of polyhydric alcohols; glycidyl ethers of polyhydric phenols; glycidyl esters of polycarboxylic acids; and, epoxidized polyethylenically unsaturated hydrocarbons.

4. The two-component (2K) composition according to claim 1, wherein said part a) comprises at least one diepoxide compound having an epoxide equivalent weight of less than 500 g/eq.

5. The two-component (2K) composition according to claim 4, wherein said part a) comprises at least one diepoxide compound selected from the group consisting of: bisphenol A based diglycidylethers; hydrogenated bisphenol A based diglycidylethers; bisphenol F diglycidyl ethers; and, hydrogenated bisphenol F based diglycidylethers.

6. The two-component (2K) composition according to claim 1, wherein the second component is characterized by comprising, based on the total weight of polyamines in said second component:
from 5 to 50 wt. % of b) i) meta-xylenediamine (MXDA);
from 50 to 95 wt. % of b) ii) said at least one cycloaliphatic primary diamine.

7. The two-component (2K) composition according to claim 1, wherein the second component is characterized by comprising, based on the total weight of polyamines in said second component:
from 5 to 50 wt. % of b) i) meta-xylenediamine (MXDA);
from 50 to 95 wt. % of b) iii) said at least one aliphatic primary diamine compound, which compound further comprises one or more secondary amine groups.

8. The two-component (2K) composition according to claim 1, wherein the second component is characterized by comprising, based on the total weight of polyamines in said second component:
from 5 to 50 wt. % of b) i) meta-xylenediamine (MXDA);
from 25 to 90 wt. % of b) ii) said at least one cycloaliphatic primary diamine; and,
from 25 to 90 wt. % of b) iii) said at least one aliphatic primary diamine compound, which compound further comprises one or more secondary amine groups.

9. The two-component (2K) composition according to claim 1, wherein b) ii) said at least one cycloaliphatic primary diamine and b) iii) said at least one aliphatic primary diamine compound are characterized by an amine hydrogen equivalent weight of not more than 150 g/eq.

10. The two component (2K) composition according to claim 1, wherein b) iii) said at least one aliphatic primary diamine compound is selected from the group consisting of: 3-(2-aminoethyl)aminopropylamine; triethylenetetramine (TETA); tetraethylenepentamine (TEPA); and, pentaethylenehexamine (PEHA).

11. The two component (2K) composition according to claim 1 comprising from 5 to 30 wt. %, based on the weight of the composition, of c) said least one phenolic aldehyde resin.

12. The two component (2K) composition according to claim 1, wherein said at least one phenolic aldehyde resin is obtained by reacting at least one phenolic compound and at least one aldehyde having the general formula R^{a}—(CHO)_{b}, wherein: R^{a} is H, C₁-C₈ alkyl or C₂-C₈ alkenyl; and, b is 1 or 2.

13. The two component (2K) composition according to claim 1, wherein said at least one phenolic compound comprises phenol.

14. A two-component (2K) curable composition according to claim 1, said composition comprising:
a first component comprising:
a) at least one diepoxide compound selected from the group consisting of: bisphenol A based diglycidylethers; hydrogenated bisphenol A based diglycidylethers; bisphenol F diglycidyl ethers; and, hydrogenated bisphenol F based diglycidylethers; and,
a second component comprising:
b) a mixture of polyamines of which each polyamine has at least two amine hydrogens reactive toward epoxide groups, said mixture comprising:
b) i) meta-xylenediamine (MXDA); and,
b) ii) at least one cycloaliphatic primary diamine having an amine hydrogen equivalent weight of not more than 150 g/eq; and/or,
b) iii) at least one aliphatic primary diamine compound selected from the group consisting of: 3-(2-aminoethyl)aminopropylamine; triethylenetetramine (TETA); tetraethylenepentamine (TEPA); and, pentaethylenehexamine (PEHA); and,
c) at least one phenolic aldehyde resin obtained by reacting at least one phenolic compound and at least one aldehyde having the general formula R^{a}—(CHO)_{b}, wherein:
R^{a} is H, C₁-C₈alkyl or C₂-C₈ alkenyl; and,
b is 1 or 2,
wherein said curable composition is characterized by a stoichiometric ratio of the amine hydrogen atoms of said second component to the epoxy groups of said first component (a) of from 0.5:1 to 1.2:1.

15. A cured product obtained from the two component (2K) composition as defined in claim 1.
